(19) United States
(12) Patent Application Publication
(10) Pub. No.: US 2013/0208939 A1
(43) Pub. Date: Aug. 15, 2013

(54) Earphone With Cable Support

(71) Applicant: Timothy Val Kolton, Hollywood, CA (US)

(72) Inventor: Timothy Val Kolton, Hollywood, CA (US)

(21) Appl. No.: 13/396,440

(22) Filed: Feb. 14, 2012

(51) Int. Cl. H04R 1/10

(52) U.S. Cl. 381/381

(57) ABSTRACT

An earphone support for an in-ear, earbud-type of headphone has an earphone with a portion for insertion into a user's ear canal, and a portion for connecting to a cable. An armature connects the earphone to the cable and the armature is associated with a connector for maintaining a portion of the earphone cable in a slack condition when another portion or the earphone cable is drawn taught. It is anticipated that support for the slack portion of the cable may be provided by a separate ear hook apparatus, or by a loop formed of the earphone cable.

### BACKGROUND

The present invention relates to earphones for personal use, and more particularly to an earphone apparatus providing cable support for sound dampening and resisting unintended earphone removal.

### SUMMARY

An earbud-type earphone having a cable support is disclosed. The apparatus includes an earbud-type earphone, in a preferred embodiment a conventional in-ear earphone having an in-ear portion bearing the earphone's transducer or sound producing apparatus, designed for partial insertion into a user's ear canal, and a cable connecting portion preferably affixed to the earphone at a location outside a user's ear canal when the earphone is in use.

The earphone's cable connecting portion is connected to an earphone cable having a first end connected to the cable connecting portion and a second end bearing a plug or jack. The earphone cable may be of varying length and it is anticipated that it may be sleeved in a variety of materials, including materials adapted to prevent tangling or facilitate untangling of the cable. The plug or jack may be a conventional 3.5 mm headphone jack, although any electrical connector is contemplated.

A connector associated with the earphone is adapted to hold the cable in a manner so that slack is maintained along a length of cable between the connector and earphone, while allowing a second cable length between the connector and jack to grow taught. It is anticipated changes in tension may be caused by the earphone cable catching on objects while a user is in motion, or otherwise being pulled beyond the cable's length.

An armature may be attached to and comprise a portion of the earphone. The armature serves two purposes. First, it extends away from the earphone, creating an additional sound dampening effect on cable noise. Second, the armature may be angled to decrease the distance of the cable length between the connector and earphone. In that manner, a shorter slack portion of cable may be maintained when the apparatus is in use.

In one exemplary embodiment, the ear-phone functions with an associated ear hook apparatus. The ear hook is disposed between the pinna of a user's ear and the user's head, the cable being connected to the ear hook. In one embodiment the connector is disposed at the bottom portion of the ear hook, which is situated under a user's ear lobe. In that manner, the earphone cable may exit the earphone, in a slack condition, and be connected to the ear hook which preserves slack in the cable as the portion of the cable below the ear hook grows taught. It is also anticipated that the connector may be incorporated on the earphone cable and the connector designed to interface with the ear hook. The connector may be a pressure fit connector to allow the cable to be removably retained therein.

An alternative embodiment of the apparatus foregoes the need for a separate ear hook apparatus in order to function. Rather, the connector in this embodiment is associated with the armature. The connector may be affixed to the armature, or a portion of the armature may be formed as the connector. Preferably, the connector is located at the distal end of the armature. In this manner, the armature is able to connect to the cable at a location near the top of a user's ear lobe.

The advantage of having a cable connection near the top of a user's ear lobe is due to the arrangement of the cable in a loop, designed to fit between the pinna of a user's ear and the user's head. In an embodiment having the connector associated with the armature, the cable may also be removably retained in a pressure fit. By having the connecter associated with the armature, the cable loop can be maintained under a user's ear lobe.

In the various contemplated embodiments, the cable portion may be sleeved in different materials above and below the connector. In this manner, a material that maximizes sound dampening from contact may be used above the connector to help isolate sound from the earphone, while a material that maximizes de-tangling may be used for the length of cable below the connector to help prevent cable tangles.

### BRIEF DESCRIPTION OF THE FIGURES

FIG. 1 is an enlarged perspective view of a cable supporting earphone according to a first embodiment having an associated ear hook.

FIG. 2 is a perspective view of the earphone according to the first embodiment with a cable connected.

FIG. 3 is a perspective view of a cable supporting earphone according to a second embodiment.

FIG. 4 is a perspective view of a cable supporting earphone according to the second embodiment supporting a cable.

FIG. 5 is a perspective view of the earphone according to the first embodiment installed on a wearer's ear.

### DESCRIPTION

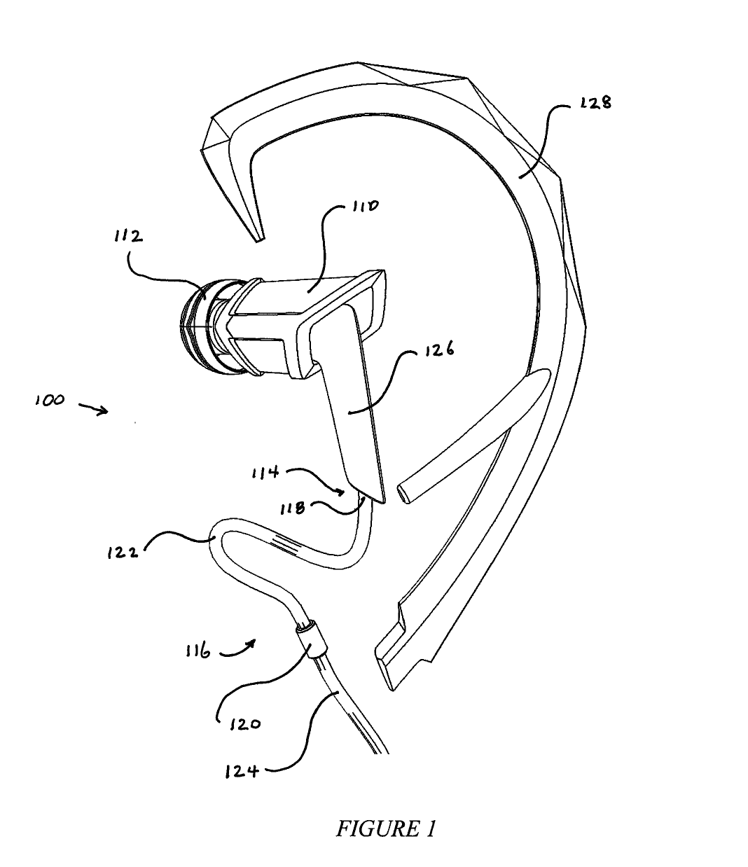

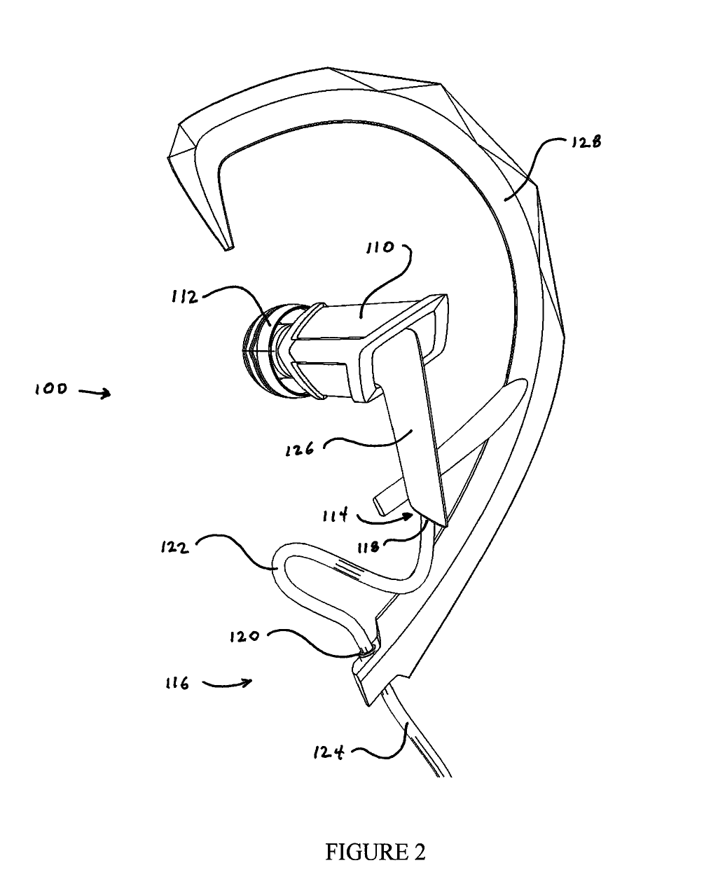

Referring to FIGS. 1 and 2, an earbud-type earphone having a cable support and connector is disclosed. The apparatus 100 includes an earbud-type earphone 110, in a preferred embodiment a conventional in-ear earphone 110 having an in-ear portion 112 bearing the earphone's 110 transducer or sound producing apparatus (not shown), designed for partial insertion into a user's ear canal (not shown), and a cable connecting portion 114 preferably affixed to the earphone 110 at a location outside a user's ear canal (not shown) when the apparatus 100 is in use.

The earphone's cable connecting portion 114 is connected to an earphone cable 116 having a first end 118 connected to the cable connecting portion 114 and a second end bearing a plug or jack (not shown). The earphone cable 116 may be of varying length and may be sleeved in a variety of materials, including materials adapted to prevent tangling or facilitate untangling of the cable 116, and materials adapted to dampen sound. The plug or jack (not shown) may be a conventional 3.5 mm headphone jack, although any electrical connector is contemplated.

A connector 120 associated with the apparatus 100 is adapted to hold the cable 116 in a manner so that slack is maintained along a first length 122 of cable 116 between the connector 200 and earphone 110, while allowing a second length 124 of cable 116 between the connector 120 and jack (not shown) to grow taught. It is anticipated changes in tension may be caused by the cable 116 catching on objects while a user is in motion, or otherwise being pulled beyond the cable's 116 length.

It is anticipated an armature 126 may be attached to and comprise a portion of the earphone 110. The armature 126 serves two purposes. First, it extends away from the earphone 110, creating an additional sound dampening effect on cable 116 noise. Second, the armature 126 may be angled to decrease the distance of the first length 122 of cable 116 between the connector 120 and earphone 110. In that manner, a shorter slack portion of cable 116 may be maintained, when the apparatus is in use.

In one exemplary embodiment, the apparatus 100 functions with an associated ear hook 128. The ear hook 128 is disposed between the pinna of a user's ear (not shown) and the user's head (not shown), and the cable 116 is connected to the ear hook 128. In one embodiment the connector 120 is disposed at the bottom portion of the ear hook 128, which is situated below a user's ear (not shown). In that manner, the earphone cable 116 may exit the earphone 110 in a slack condition, and be connected to the ear hook 128 which preserves slack in the cable 116 as the portion of the cable 116 below the ear hook 128 grows taught. It is also anticipated that the connector 120 may be incorporated on the earphone 110 cable 116 and the connector 120 designed to interface with the ear hook 128. The connector 120 may be a pressure fit connector 120 to allow the cable 116 to be removably retained therein.

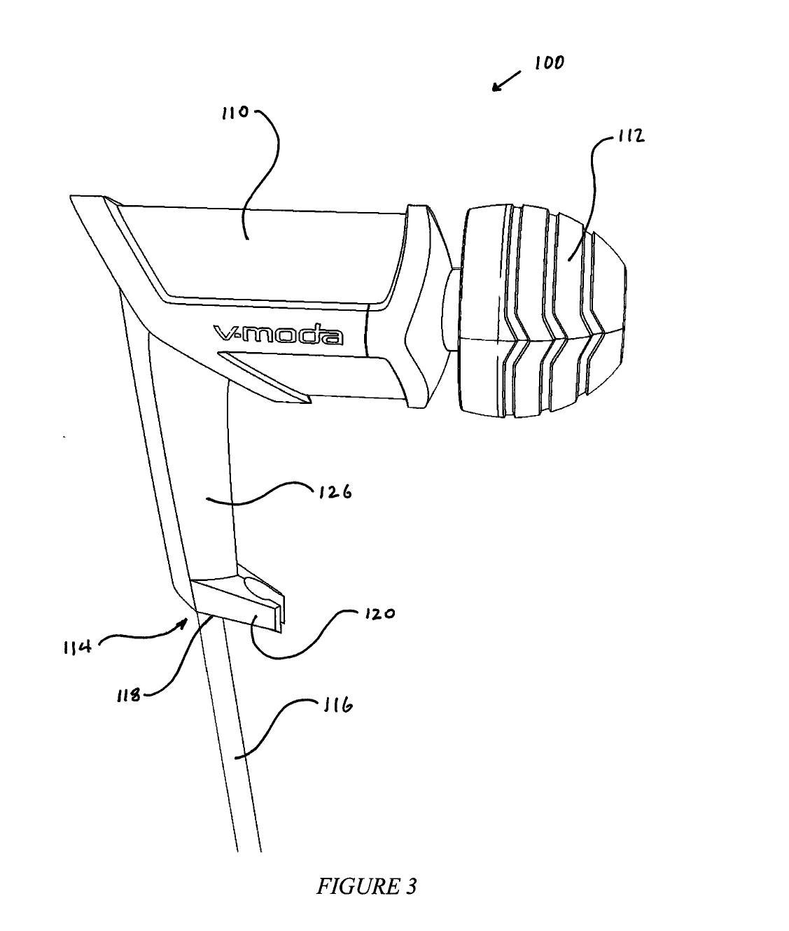

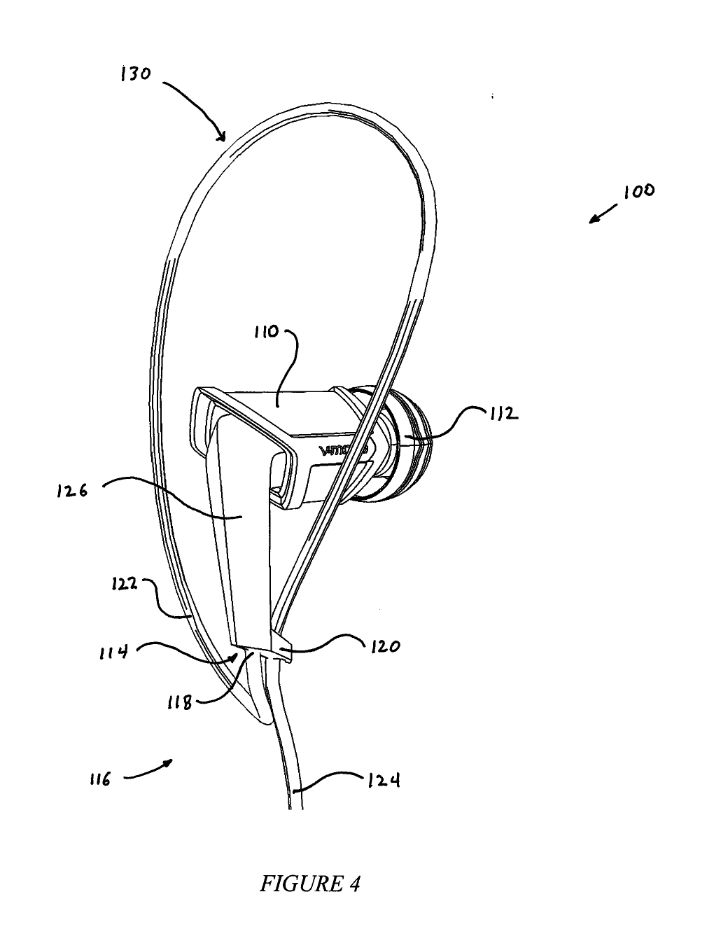

Referring to FIGS. 3 and 4, an alternative embodiment of the apparatus 100 foregoes the need for a separate ear hook 128 in order to function. Rather, the connector 120 in this embodiment is associated with the armature 126. The connector 120 may be affixed to the armature 126, or a portion of the armature 126 may form the connector 120. Preferably, the connector 120 is located at the distal end of the armature 126. In this manner, the armature 126 is able to connect to the cable 116 at a location near the top of a user's ear lobe (not shown).

The advantage of having a cable 116 connector 120 near the top of a user's ear lobe is due to the arrangement of the first portion 122 of the cable 116 in a loop 130, designed to fit over and between the pinna of a user's ear, and the user's head (not shown). In an embodiment having the connector associated with the armature 126, the cable 116 may also be removably retained in a pressure fit. By having the connecter 120 associated with the armature 126, the cable loop 130 can be maintained under a user's ear lobe.

In the various contemplated embodiments, the first portion 122 of the cable 116 and second portion 124 of the cable 116 may be sleeved in different materials above and below the connector 120. In this manner, a material maximizing sound dampening due to physical contact may be used above the connector 120 to help isolate sound in the earphone 110, while a material maximizing de-tangling may be used for the length of cable 116 below the connector 120 to help prevent cable 116 tangles.

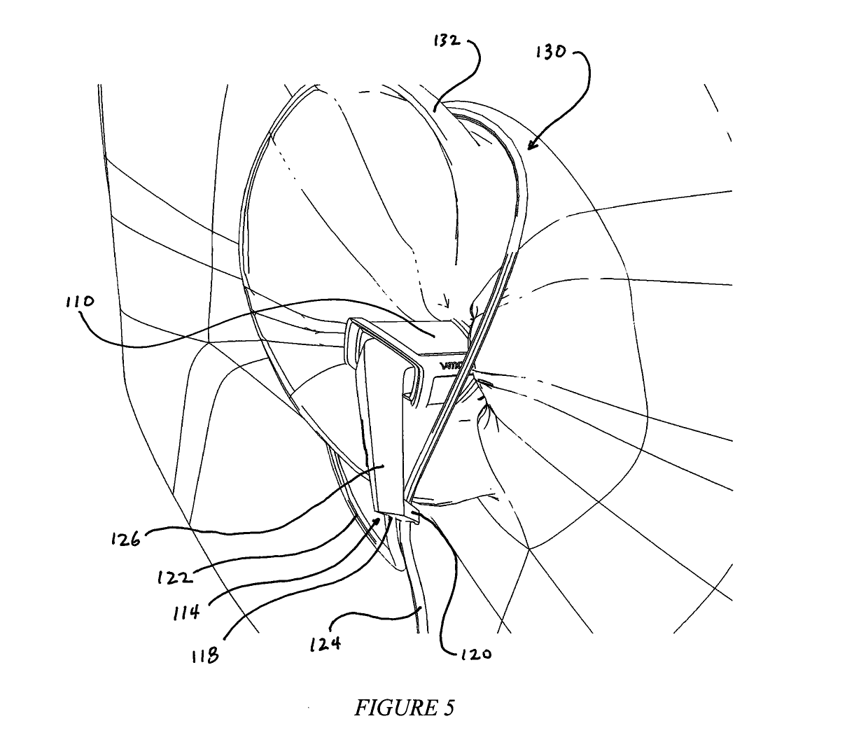

Referring to FIG. 5, the apparatus 100 is shown installed in a user's ear 132. The cable 116, is connected to the connector 120 at the end of the armature 126, to form a loop 130 that travels behind the user's ear 132. In order to use the apparatus 100, a user creates a loop 130 in the earphone 110 cable 116 by fastening a portion of the cable 116 to a connector 120 on the earphone. The loop of the cable is then slid over the user's ear 132, and the cable 116 connected to an apparatus for producing sound, whereby slack is preserved in the cable 116 between the earphone 110 and connector 120, while the rest of the cable 116 may be pulled taught.

While the present invention has been described with regards to particular embodiments, it is recognized that additional variations of the present invention may be devised by persons skilled in the art without departing from the inventive concepts disclosed herein. By way of example, although the preferred embodiments have been shown and described in terms of an ear hook or loop, additional methods of employing a connector along a cable length are contemplated.

What is claimed is:

1. An earbud-type earphone and support comprising:
an earbud-type earphone having an in-ear portion bearing a transducer and designed for insertion into a user's ear canal, and a cable connecting portion;
an earphone cable having a first end connected to the cable connecting portion, and a second end bearing a jack; and
a connector, adapted to hold the cable thereby maintaining slack along a first cable length between the connector and earphone when a second cable length between the connector and jack is taught;

2. The earphone of claim 1 including an armature extending from the cable connecting portion and having a distal end.

3. The earphone of claim 1 wherein the connector is disposed on an ear hook, the ear hook adapted to engage a user between the pinna of the user's ear and the user's head.

4. The earphone of claim 3 wherein the connector is removable from the ear hook.

5. The earphone of claim 2 wherein the connector is located on the armature at the distal end.

6. The earphone of claim 5 wherein the cable is removably retained by the connector in a pressure fit.

7. The earphone of claim 1 wherein the first cable portion, when connected, forms a loop adapted to rest between the pinna of a user's ear and a user's head.

8. The earphone of claim 1 wherein the first cable portion is sleeved in a different material than the second cable portion.

9. An earbud-type earphone support comprising:
an earbud-type earphone having an ear portion bearing a transducer and designed to accommodate a user's ear canal and an armature having a distal end extending therefrom;
an earphone cable having a first end connected to the distal end of the armature, and a second end bearing a jack; and
a connector disposed along the cable and adapted to hold the cable such that slack is maintained along a first cable portion between the connector and earphone when a second cable portion between the connector and jack are taught;

10. The earphone of claim 9 wherein the connector is disposed on the armature.

11. The earphone of claim 9 wherein the connector is adapted to removably retain the cable in a pressure fit.

12. The earphone of claim 9 wherein the first cable portion, when connected, is a loop adapted to rest between the pinna of a user's ear and a user's head.

13. The earphone of claim 9 wherein the first cable portion is sleeved in a different material than the second cable portion.

14. A method of supporting an earbud-type earphone and dampening noise generated by an earphone cable comprising the steps of:
creating a loop in the earphone cable by fastening a portion of the cable to a connector on the earphone;
situating the loop of cable over the pinna of a user's ear; and
connecting the earphone to an apparatus for producing sound, whereby when the cable is drawn taught between the apparatus and connector, slack in the cable loop around the user's ear is maintained.

15. The method of claim 14 wherein the portion of the cable forming the loop is sleeved in a different material than the portion of the cable between the apparatus and connector.
